(19) United States
(12) Patent Application Publication
(10) Pub. No.: US 2025/0365028 A1
(43) Pub. Date: Nov. 27, 2025

(54) UTILIZATION OF NON CARRIER AGGREGATED FILTER NETWORKS AS COMPENSATION IN SWITCHED ANTENNA MULTIPLEXER APPLICATIONS

(71) Applicant: Qorvo US, Inc., Greensboro, NC (US)

(72) Inventors: Jason Brandon Steighner, Munich (DE); Loizos Loizou, Grasbrunn (DE)

(21) Appl. No.: 19/203,327

(22) Filed: May 9, 2025

Related U.S. Application Data
(60) Provisional application No. 63/651,499, filed on May 24, 2024.

(51) Int. Cl. H04B 1/40; H04B 1/00

(52) U.S. Cl. CPC H04B 1/40; H04B 1/0003; H04B 1/0096

(57) ABSTRACT

Systems and methods of operating radio frequency (RF) front-end circuitry are disclosed. In some embodiments, the RF front-end circuitry has various transceiver circuits. Each of the transceiver circuits includes a filter network and downstream/upstream circuitry coupled to the filter network. During carrier aggregation, the downstream/upstream circuitry of several transceiver circuits may be activated and selectively coupled to an antenna. In addition, transceiver circuits with deactivated downstream/upstream circuitry may also be selectively coupled to the antenna. In this manner, filter networks in transceiver circuits with deactivated downstream/upstream circuitry can be utilized for impedance compensation and impedance matching.

### RELATED APPLICATIONS

This application claims the benefit of provisional patent application Ser. No. 63/651,499, filed May 24, 2024, the disclosure of which is hereby incorporated herein by reference in its entirety.

### FIELD OF THE DISCLOSURE

This disclosure relates to radio frequency front-end circuitry and methods of operating the same.

### BACKGROUND

In order to multiplex multiple filters together within a network of filters (i.e., a filter network), matching components are generally required within the filter network. These matching components within the filter network also function for carrier aggregation cases where combinations of multiple filter networks are multiplexed together at the same antenna. For switched antenna multiplexer applications where multiple filter networks are switched into the same antenna to enable carrier aggregation, it is often the case that either the single filter network (i.e., stand-alone) and/or combined filter networks (i.e., carrier aggregation) will demonstrate a variation of in-band performance between these two modes of operation. A common solution to improve the in-band performance of filter paths that need to operate in stand-alone and carrier aggregation modes of operation is to utilize an additionally switched-in matching network (commonly referred to as compensation) to help compensate for any mismatch seen by any of the filter networks' filters. This comes with the added cost of additional space on the laminate for the matching component (commonly a surface mount device) and an additional switch arm on the antenna switch. This requires a larger die for the multiplexing switch device. Additionally, this additional switch arm will introduce capacitive loading (in an off state) for all other paths that are connected to the same antenna node with the switch device, resulting in higher losses for these other paths.

### SUMMARY

In some embodiments, radio frequency (RF) front-end circuitry includes a first transceiver circuit including a first filter network and first downstream/upstream RF circuitry, wherein the first downstream/upstream RF circuitry is configured to be operational and non-operational based on a first control output; a second transceiver circuit including a second filter network and second downstream/upstream RF circuitry, wherein the second downstream/upstream RF circuitry is configured to be operational and non-operational based on a second control output; a switch device connected to an antenna, wherein the switch device is configured to selectively couple and selectively decouple the first transceiver circuit and the second transceiver circuit to the antenna; and control circuitry configured to selectively couple both the first transceiver circuit and the second transceiver circuit to the antenna; generate the first control output such that the first downstream/upstream RF circuitry is operational with the first filter network while both the first transceiver circuit and the second transceiver circuit are selectively coupled to the antenna; and generate the second control output such that the second downstream/upstream RF circuitry is non-operational with the second filter network while both the first transceiver circuit and the second transceiver circuit are selectively coupled to the antenna and while the first downstream/upstream RF circuitry is operational with the first filter network. In some embodiments, the RF front-end circuitry further includes a third transceiver circuit including a third filter network and third downstream/upstream RF circuitry, wherein the third downstream/upstream RF circuitry is configured to be operational and non-operational with the third filter network based on a third control output, wherein the switch device is configured to selectively couple and selectively decouple the third transceiver circuit to the antenna; and the control circuitry is further configured to selectively couple the third transceiver circuit to the antenna; and generate the third control output such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network. In some embodiments, the first filter network includes a first bulk acoustic wave (BAW) filter or a first surface acoustic wave (SAW) filter. In some embodiments, the first filter network includes a second BAW filter or a second SAW filter. In some embodiments, the second filter network includes a first BAW filter or a first SAW filter. In some embodiments, the first filter network defines a first passband in a first frequency range. In some embodiments, the second filter network defines a second passband that is outside of the first frequency range. In some embodiments, the second filter network provides a capacitive response within the first frequency range.

In some embodiments, a method of operating RF front-end circuitry includes selectively coupling both a first transceiver circuit and a second transceiver circuit to an antenna, wherein the first transceiver circuit includes a first filter network and first downstream/upstream RF circuitry, wherein the first downstream/upstream RF circuitry is configured to be operational and non-operational with the first filter network based on a first control output, wherein the second transceiver circuit includes a second filter network and second downstream/upstream RF circuitry, and wherein the second downstream/upstream RF circuitry is configured to be operational and non-operational with the second filter network based on a second control output; generating the first control output such that the first downstream/upstream RF circuitry is operational with the first filter network while both the first transceiver circuit and the second transceiver circuit are selectively coupled to the antenna; and generating the second control output such that the second downstream/upstream RF circuitry is non-operational with the second filter network while both the first transceiver circuit and the second transceiver circuit are selectively coupled to the antenna and the first downstream/upstream RF circuitry is operational with the first filter network. In some embodiments, the method further includes selectively coupling a third transceiver circuit to the antenna, wherein the third transceiver circuit includes a third filter network and third downstream/upstream RF circuitry, wherein the third downstream/upstream RF circuitry is configured to be operational and non-operational with the third filter network based on a third control output; and generating the third control output such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network. In some embodiments, the first filter network includes a first BAW filter or a first SAW filter. In some embodiments, the first filter network includes a second BAW filter or a second SAW filter. In some embodiments, the second filter network includes a first BAW filter or a first SAW filter. In some embodiments, the first filter network defines a first passband in a first frequency range. In some embodiments, the second filter network defines a second passband that is outside of the first frequency range. In some embodiments, the second filter network provides a capacitive loading within the first frequency range.

In some embodiments, a user element includes RF front-end circuitry, and the RF front-end circuitry includes a first transceiver circuit including a first filter network and first downstream/upstream RF circuitry, wherein the first downstream/upstream RF circuitry is configured to be operational and non-operational based a first control output; a second transceiver circuit including a second filter network and second downstream/upstream RF circuitry, wherein the second downstream/upstream RF circuitry is configured to be operational and non-operational based on a second control output; a switch device connected to an antenna, wherein the switch device is configured to selectively couple and selectively decouple the first transceiver circuit and the second transceiver circuit to the antenna; and control circuitry configured to selectively couple both the first transceiver circuit and the second transceiver circuit to the antenna; generate the first control output such that the first downstream/upstream RF circuitry is operational with the first filter network while both the first transceiver circuit and the second transceiver circuit are selectively coupled to the antenna; and generate the second control output such that the second downstream/upstream RF circuitry is non-operational with the second filter network while both the first transceiver circuit and the second transceiver circuit are selectively coupled to the antenna and while the first downstream/upstream RF circuitry is operational with the first filter network. In some embodiments, the RF front-end circuitry further includes a third transceiver circuit including a third filter network and third downstream/upstream RF circuitry, wherein the third downstream/upstream RF circuitry is configured to be operational and non-operational with the third filter network based on a third control output, wherein the switch device is configured to selectively couple and selectively decouple the third transceiver circuit to the antenna; the control circuit is further configured to selectively couple the third transceiver circuit to the antenna; generate the third control output such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network. In some embodiments, the first filter network includes a first BAW filter or a first SAW filter. In some embodiments, the first filter network includes a second BAW filter or a second SAW filter.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates radio frequency (RF) front-end circuitry, in accordance with some embodiments;

FIG. 2 illustrates an equivalent capacitance over a frequency of a filter network, in accordance with some embodiments;

FIG. 3 illustrates a representation of a frequency spectrum showing carrier aggregation of different passbands for filter networks that are operational with their downstream/upstream circuitry and a passband of a filter network that is non-operational with its downstream/upstream circuitry, in accordance with some embodiments;

FIG. 4 is a Smith Chart illustrating an impedance match of a filter network operating in a receive band B39 without impedance compensation and with impedance compensation provided by using a filter network operating in a frequency band B30;

FIG. 5 is a graph illustrating an S11 response of a filter network operating in a receive band B39 without impedance compensation and with impedance compensation provided by using a filter network operating in a band B30;

FIG. 6 is a flow diagram illustrating a method of operating RF front-end circuitry, in accordance with some embodiments; and

FIG. 7 is a user element, in accordance with some embodiments.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It should be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It should also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It should be understood that, although the terms “upper,” “lower,” “bottom,” “intermediate,” “middle,” “top,” and the like may be used herein to describe various elements, these elements should not be limited by these terms. These terms are only used to distinguish one element from another. For example, a first element could be termed an “upper” element and, similarly, a second element could be termed an “upper” element depending on the relative orientations of these elements, without departing from the scope of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

Systems and methods of operating radio frequency (RF) front-end circuitry are disclosed. The techniques disclosed herein take advantage of the fact that some transceiver chains are not always used. For example, transceiver chains for transmission bands in North America are not always active in Europe, and vice versa. Filter networks in transceiver chains and deactivated transceiver circuits can, thus, be used to provide impedance compensation and, therefore, better matching for transceiver circuitry that is active. In this manner, carrier aggregation can be provided with active transceiver chains while providing impedance compensation with filter networks in inactive transceiver circuitry in order to present a consistent impedance at an antenna, regardless of the combination of transceiver chains being utilized during carrier aggregation.

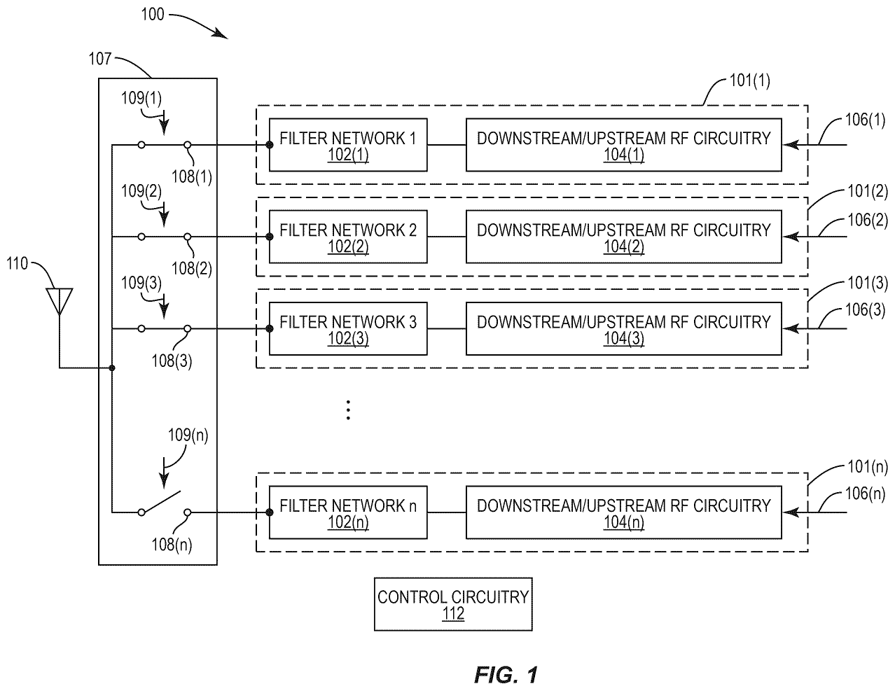

FIG. 1 illustrates RF front-end circuitry 100, in accordance with some embodiments.

The RF front-end circuitry 100 includes transceiver circuits (referred to generally or generically as transceiver circuits 101 and specifically as transceiver circuits 101(1)-101(n)). Each of the transceiver circuits 101 includes a filter network (referred to generally or generically as filter networks 102 and specifically as filter networks 102(1)-102(n)) and downstream/upstream RF circuitry (referred to generally or generically as downstream/upstream RF circuitry 104 and specifically as downstream/upstream RF circuitry 104(1)-104(n)). Each of the filter networks 102 defines a passband, where RF signals within the frequency range of the passband are permitted to pass. It should be noted that some of the filter networks 102 may define different passbands, while some of the filter networks 102 may share passbands centered around the same frequency. For example, each of the filter networks 102 may also define a stop band. In some embodiments, one or more of the filter networks 102 may include a bulk acoustic wave (BAW) filter, an acoustic filter, and/or a surface acoustic wave (SAW) filter. In some embodiments, each of the BAW filters may present a capacitive response outside of their passbands. In some embodiments, each of the filter networks 102 are formed from other components, such as inductive devices, capacitive devices, and resistive devices.

Each of the downstream/upstream RF circuitry 104 may be upstream circuitry, downstream circuitry, or both upstream and downstream circuitry. For example, the upstream circuitry may include a power amplifier, a modulator, a baseband processor, and/or the like. The downstream circuitry may include a low noise amplifier, an intermediate frequency amplifier, a demodulator, a detector, or a baseband processor. Other circuitry that may be included in the downstream/upstream RF circuitry 104 includes a microcontroller, analog-to-digital converters (ADCs) or digital-to-analog converters (DACs), digital signal processing circuitry, power management circuitry, interface circuitry, frequency synthesizers, an automatic gain control, and/or the like.

Each of the downstream/upstream RF circuitry 104 is configured to be operational and non-operational with their respective ones of the filter networks 102 based on one of the different control outputs (referred to generally or generically as control outputs 106 and specifically as control outputs 106(1)-106(n)). In some embodiments, one or more of the control outputs 106 may include one or more control signals that operate to activate and deactivate their corresponding ones of the downstream/upstream RF circuitry 104. In this manner, the filter networks 102 are non-operational with their respective ones of the downstream/upstream RF circuitry 104 while the downstream/upstream RF circuitry 104 is deactivated. In some embodiments, one or more of the control outputs 106 may include one or more control signals that open and close an RF signal path or RF signal paths between the corresponding filter network 102 and the corresponding downstream/upstream RF circuitry 104. In this case, by opening RF filter paths between the filter network 102 and the corresponding downstream/upstream RF circuitry 104, the filter network 102 and the corresponding downstream/upstream RF circuitry 104 may be non-operational, even though the downstream/upstream RF circuitry 104 is activated. The filter network 102 and the corresponding downstream/upstream RF circuitry 104 are operational whenever RF signal paths between the filter network 102 and the corresponding downstream/upstream RF circuitry 104 is closed and when the corresponding downstream/upstream RF circuitry 104 is activated. When the filter network 102 is operational with its corresponding one of the downstream/upstream RF circuitry 104, the filter networks 102 can be utilized to pass RF signals to their corresponding passbands and then to their corresponding ones of the downstream/upstream RF circuitry 104. However, when the filter network 102 is non-operational with its corresponding one of the downstream/upstream RF circuitry 104, RF signals do not pass between the filter network 102 and its corresponding one of the downstream/upstream RF circuitry 104, because one or more RF filter paths are open and/or because the corresponding downstream/upstream RF circuitry 104 is deactivated. Thus, when the filter networks 102 are non-operational with their corresponding ones of the downstream/upstream RF circuitry 104, the filter networks 102 can be used as impedances for other ones of the transceiver circuits 101. There is an integer number n of the transceiver circuits 101. The integer n may be any number greater than 1. As shown, each of the transceiver circuits 101 is selectively coupled and decoupled by a different switch (referred to generally or generically as switches 108 and specifically as switches 108(1)-108(n)) in a switch device 107.

The RF front-end circuitry 100 includes the switch device 107. The switch device 107 is configured to selectively couple each of the transceiver circuits 101 to at least one antenna 110. In FIG. 1, only a single one of the antenna 110 is shown. However, in other embodiments, multiple ones of the antenna 110 may be selectively coupled to one or more of the transceiver circuits 101, thereby allowing for the multiplexing of antennas (such as the antenna 110).

There are various combinations between high band (HB) and mid band (MB) RF signals that could be provided by the RF front-end circuitry 100. For example, the transceiver circuits 101 correspond to B1+B3+B40+B32+B7, B1+B3+B40+B32+B41, B25+B70+B66+B41, B25+B70+B66+B30, B25+B70+B66+B7 paths along with combinations of HB transceiver chains for configurations of bands B7, B30, and B41. In other embodiments, these transceiver circuits 101 are not used in combination and are operated in a stand-alone fashion. Regardless of which one of the combinations of the transceiver circuits 101 is being utilized, the transceiver circuits 101 that are operational need to see a consistent impedance during operation. In this embodiment, the RF front-end circuitry 100 includes a control circuit 112 that is configured to generate the control output 106 to make the downstream/upstream RF circuitry 104 operational and non-operational with their corresponding ones of the filter networks 102. Furthermore, the control circuit 112 is configured to operate the switch device 107 in order to selectively couple and decouple the transceiver circuits 101 to the antenna 110. The control circuit 112 is configured to generate corresponding control signals (referred to generally or generically as control signals 109 and specifically as control signals 109(1)-109(n)) to open and close corresponding ones of the switches 108(1)-108(n). In order to achieve the best performance across all the combinations of the transceiver circuits 101 that are selectively coupled to the antenna 110, the control circuit 112 is configured to make the filter networks 102 operational with the downstream/upstream RF circuitry 104 for active ones of the transceiver circuits 101 while selectively coupling the transceiver circuits 101 with the filter networks 102 that are non-operational with the corresponding downstream/upstream RF circuitry 104. In this manner, the filter networks 102 that are non-operational with the corresponding downstream/upstream RF circuitry 104 can be used to present a consistent impedance to the active transceiver circuits 101 and thereby can provide better performance.

In some embodiments, the filter networks 102 in the transceiver circuits 101 that are non-operational with the corresponding downstream/upstream RF circuitry 104 are used for frequency bands that are not utilized in a particular geographic region. For example, if the RF front-end circuitry 100 is being utilized in Europe, then the filter networks 102 of the transceiver circuits 101 that are utilized in North America can be used to provide a consistent impedance for the active transceiver circuits 101 in Europe.

In one example, the control circuit 112 is configured to operate the switch device 107 so as to selectively couple the transceiver circuits 101(1), 101(2), 101(3) to the antenna 110 while the transceiver circuit 101(n) is selectively decoupled from the antenna 110. In one embodiment, the filter network 102(1) is a diplexer that defines passbands for bands B34, B39; the filter network 102(2) defines a passband for the transmission passband B41, and the filter network 102(3) is a duplexer defining a passband for the passband B30. The control circuit 112 is configured to generate the control output 106(1) to activate the downstream/upstream RF circuitry 104(1), generate the control output 106(2) to activate the downstream/upstream RF circuitry 104(2), and generate the control output 106(3) to deactivate the downstream/upstream RF circuitry 104(3). In this manner, the filter network 102(3) is used as a terminating impedance so that the transceiver circuits 101(2), 101(3) see a consistent impedance during operation.

In other embodiments, the control circuit 112 may deactivate any subset of one or more of the downstream/upstream RF circuitry 104 in the transceiver circuits 101 and activate any subset of one or more of the downstream/upstream RF circuitry 104. The control circuit 112 can also operate the switch device 107 to selectively couple any subset of more than one of the transceiver circuits 101. In this manner, the filter networks 102 corresponding to the active downstream/upstream RF circuitry 104 are utilized to pass RF signals through the active downstream/upstream RF circuitry 104 while the filter networks 102 corresponding to the deactivated downstream/upstream RF circuitry 104 are used to present a consistent impedance to the active transceiver circuits 101.

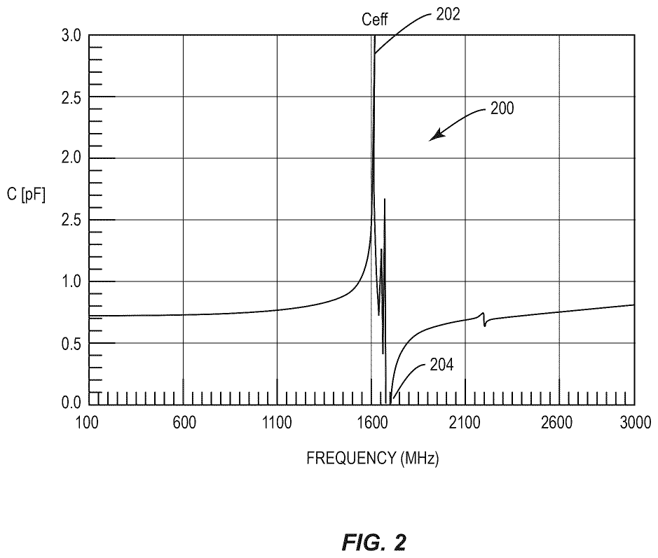

FIG. 2 illustrates an equivalent capacitance 200 over a frequency of a filter network, in accordance with some embodiments.

The equivalent capacitance 200 may be the equivalent capacitance of a filter of any of the filter networks 102 shown in FIG. 1.

The equivalent capacitance 200 illustrates the capacitance of a filter in the filter network versus a frequency. In this case, the filter in the filter network is an acoustic filter. In this embodiment, the equivalent capacitance 200 of the filter network defines a resonance 202 centered around 1600 Megahertz (MHz) and a resonance 204 centered around 1700 MHZ. At frequencies spaced at least 50 MHz below the resonance 202, the equivalent capacitance 200 presents a consistent capacitive value around 0.7 picoF arads (pF). At frequencies spaced at least 50 Mhz above the resonance 204, the equivalent capacitance 200 presents a consistent capacitive value around 0.7 pF. FIG. 2 illustrates that acoustic filters, such as a BAW filter, behave as capacitors in the out-of-band region (regions with significant frequency spacing from the resonances 202, 204) and, as such, can be used as a compensating (i.e., tuning) element. A certain combination of one or more of the filter networks 102 are deactivated, which presents a certain impedance in the frequency band of the corresponding filter networks 102 that are in the active state. The inactive filter networks 102 provide compensation and, in their out-of-band frequency ranges, act as a constant over frequency capacitive load (e.g., such as when one or more BAW filters are used in the inactive filter networks 102). The filter networks 102 do not act differently when they are operational or non-operational with their corresponding ones of the downstream/upstream RF circuitry 104 (as shown in FIG. 1). The impedance presented by the filter network 102 to the antenna 110 (as shown in FIG. 1) is similar, regardless of whether they are operational or non-operational with their corresponding ones of the downstream/upstream RF circuitry 104. However, when the filter network 102 is non-operational with their corresponding ones of the downstream/upstream RF circuitry 104, the filter network 102 that is non-operational with their corresponding ones of the downstream/upstream RF circuitry 104 is used as an impedance compensation and its purpose is to provide compensation and not to pass any signals down/up the downstream/upstream RF circuitry 104. This approach is particularly fitted for acoustic type SAW and BAW multiplexers, which are widely used in the industry for user elements. This is because the acoustic device/filters inherently have a capacitive behavior and can be used as an equivalent high-Quality (-Q) matching capacitance at frequencies away from the resonance region, as seen in FIG. 2. It should be noted that matching elements of the filter networks 102 that are non-operational with the corresponding downstream/upstream RF circuitry 104 can also provide matching outside of the active passbands.

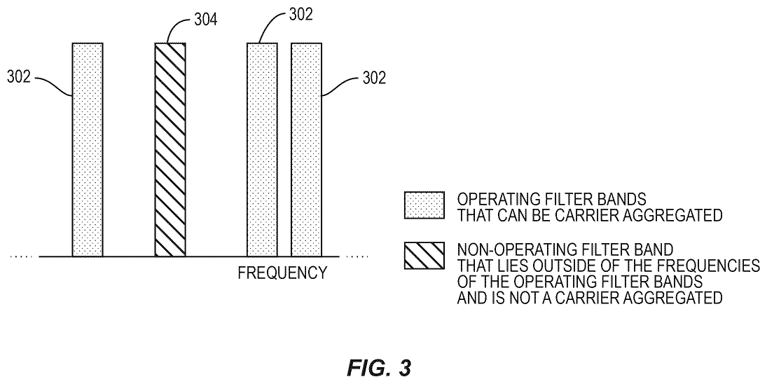

FIG. 3 illustrates a representation of a frequency spectrum showing carrier aggregation of different passbands 302 for filter networks that are operational with their downstream/upstream circuitry and a passband 304 of a filter network that is non-operational with its downstream/upstream circuitry, in accordance with some embodiments.

FIG. 3 highlights how the filter network that is non-operational with its downstream/upstream circuitry could be used for compensation by utilizing the frequency response outside of the frequency ranges of the corresponding passband 304. In some embodiments, it is worth pointing out that, due to different spectrum licenses between different geographical regions, there can be bands unique to one region that do not overlap with bands of other geographical regions. As these are not cases of carrier aggregation in any of the geographical regions, these would, by default, not operate together. However, as disclosed herein, these other available filter networks can be used as impedance compensation. In some embodiments, filter networks for the same frequency bands can be used for compensation. For example, with respect to sounding referencing signal (SRS) functionality, if a transmission filter network for the band B41 is switched between two antennas, the receive filter network for the band B41 (which has the same impedance) can be connected as compensation to a first antenna to maintain the loading conditions seen by other filters connected to the first antenna, regardless if the system does not receive the band B41.

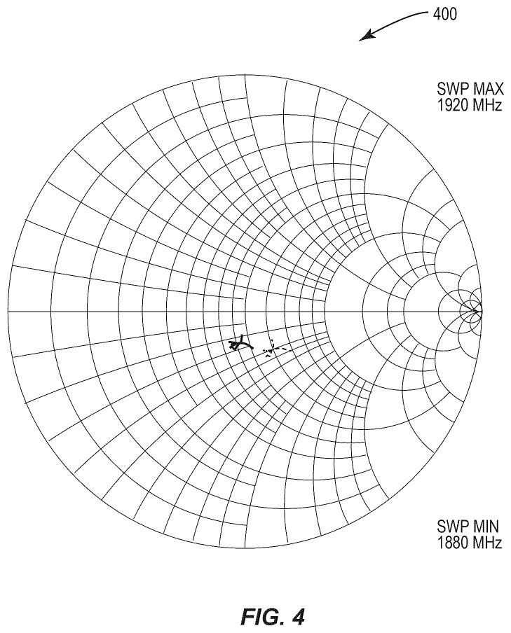

FIG. 4 is a Smith Chart 400 illustrating an impedance match of a filter network operating in the frequency band B39 without impedance compensation and with impedance compensation provided by using a filter network operating in the frequency band B30.

The filter network operating in the frequency band B39 is a time division duplex filter. In one embodiment, the filter network operating in the frequency band B39 is the filter network 102(1) shown in FIG. 1. In one embodiment, the filter network operating in the frequency band B30 is the filter network 102(3) shown in FIG. 1. Accordingly, in this example, the control circuit 112 (as shown in FIG. 1) generates the control output 106(1) (as shown in FIG. 1) so that the filter network 102(1) is operational with the downstream/upstream RF circuitry 104(1) (as shown in FIG. 1). The control circuit 112 also generates the control output 106(3) (as shown in FIG. 1) so that the filter network 102(3) is non-operational with the downstream/upstream RF circuitry 104(3) (as shown in FIG. 1). The control circuit 112 is configured to operate the switch device 107 (as shown in FIG. 1) to close the switches 108(1), 108(3) shown in FIG. 1 and open the remainder of the switches 108(2), 108(x), where x is an integer equal to or greater than 4 and equal to or less than n. As shown by FIG. 4, with the impedance compensation of the filter network 102, the impedance slides closer to the center of the Smith Chart 400.

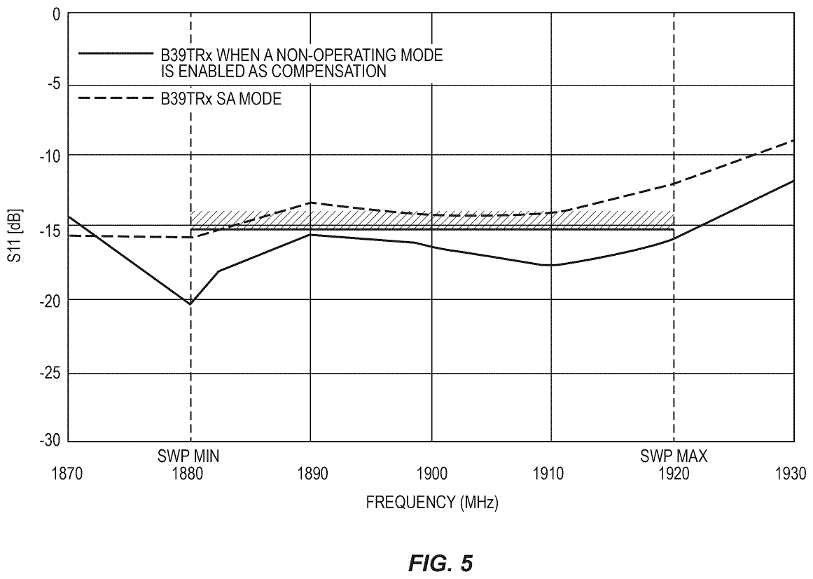

FIG. 5 is a graph illustrating an S11 response of a filter network operating in the receive band B39 without impedance compensation and with impedance compensation provided by using a filter network operating in the band B30.

As shown in FIG. 5, better matching is provided with the impedance compensation. Impedance matching at the antenna and antenna return loss are improved as a result of enabling the duplexer path in band B30 by about a 4 decibel (dB) maximum delta at 1880 MHz.

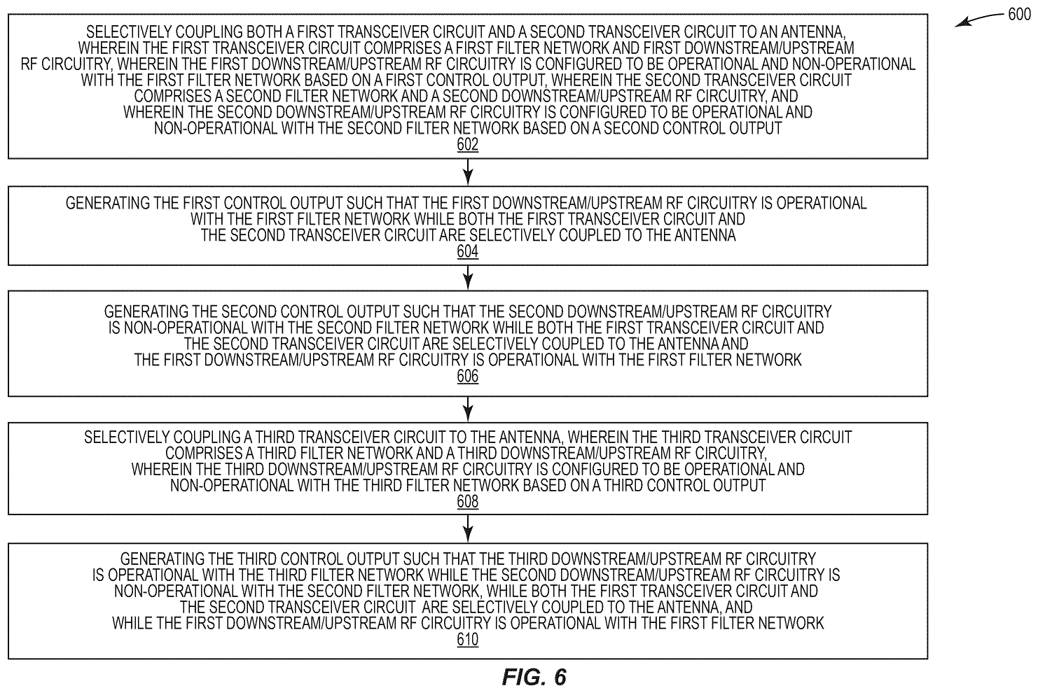

FIG. 6 is a flow diagram 600 illustrating a method of operating RF front-end circuitry, in accordance with some embodiments.

In some embodiments, the RF front-end circuitry is the RF front-end circuitry 100 shown in FIG. 1. In some embodiments, the control circuit 112 shown in FIG. 1 operates the RF front-end circuitry. The flow diagram 600 includes blocks 602-610. Flow begins at block 602.

At block 602, both a first transceiver circuit and a second transceiver circuit are selectively coupled to an antenna, wherein the first transceiver circuit comprises a first filter network and first downstream/upstream RF circuitry, wherein the first downstream/upstream RF circuitry is configured to be operational and non-operational with the first filter network based on a first control output, wherein the second transceiver circuit comprises a second filter network and second downstream/upstream RF circuitry, and wherein the second downstream/upstream RF circuitry is configured to be operational and non-operational with the second filter network based on a second control output. In some embodiments, the first transceiver circuit is one of the transceiver circuits 101 in FIG. 1. In some embodiments, the second transceiver circuit is another one of the transceiver circuits 101. In some embodiments, the first downstream/upstream RF circuitry is one of the downstream/upstream RF circuitry 104 in FIG. 1. In some embodiments, the second downstream/upstream RF circuitry is another one of the downstream/upstream RF circuitry 104. In some embodiments, the antenna is the antenna 110 in FIG. 1. In some embodiments, the first control output is one of the control outputs 106 in FIG. 1. In some embodiments, the second control output is another one of the control outputs 106. In some embodiments, the first filter network is one of the filter networks 102 in FIG. 1. In some embodiments, the second filter network is another one of the filter networks 102. In some embodiments, the control circuit 112 operates the switch device 107 (as shown in FIG. 1) to selectively couple the first transceiver circuit and the second transceiver circuit to the antenna. Flow then proceeds to block 604.

At block 604, the first control output is generated such that the first downstream/upstream RF circuitry is operational with the first filter network while both the first transceiver circuit and the second transceiver circuit are selectively coupled to the antenna. Flow then proceeds to block 606.

At block 606, the second control output is generated such that the second downstream/upstream RF circuitry is non-operational with the second filter network while both the first transceiver circuit and the second transceiver circuit are selectively coupled to the antenna and the first downstream/upstream RF circuitry is operational with the first filter network. Flow then proceeds to block 608.

At block 608, a third transceiver circuit is selectively coupled to the antenna, wherein the third transceiver circuit comprises a third filter network and a third downstream/upstream RF circuitry, wherein the third downstream/upstream RF circuitry is configured to be operational and non-operational with the third filter network based on a third control output. In some embodiments, the third transceiver circuit is one of the transceiver circuits 101 in FIG. 1. In some embodiments, the third downstream/upstream RF circuitry is one of the downstream/upstream RF circuitry 104. In some embodiments, the third control output is one of the control outputs 106. In some embodiments, the third filter network is one of the filter networks 102. In some embodiments, the control circuit 112 operates the switch device 107 to selectively coupled to the third transceiver circuit to the antenna. Flow then proceeds to block 610.

At block 610, the third control output is generated such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network. By utilizing the second filter network in the disabled second transceiver circuit whose operating frequencies do not fall within the operating frequencies of the first and third filter networks, improved matching at the antenna can be attained for the first and third filter networks from the loading provided by the second filter network. This helps improve the matching within the operating filter network path(s).

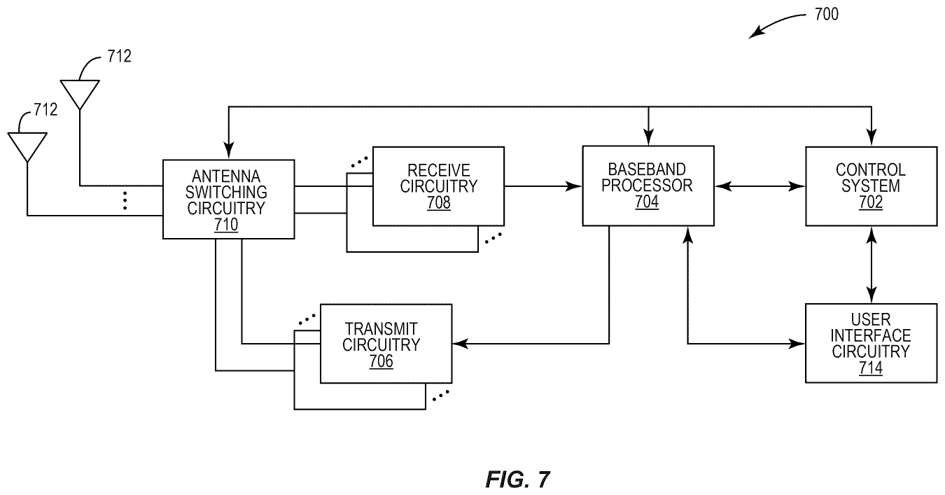

With reference to FIG. 7, the concepts described above may be implemented in various types of user elements 700, such as mobile terminals, smart watches, tablets, computers, navigation devices, access points, and the like wireless communication devices that support wireless communications, such as cellular, wireless local area network (WLAN), Bluetooth, and near-field communications. The user elements 700 will generally include a control system 702, a baseband processor 704, transmit circuitry 706, receive circuitry 708, antenna switching circuitry 710, multiple antennas 712, and user interface circuitry 714. In a non-limiting example, the control system 702 may be a field-programmable gate array (FPGA) or an application-specific integrated circuit (ASIC). In this regard, the control system 702 may include at least one or more microprocessors, embedded memory circuits, and communication bus interfaces. The receive circuitry 708 receives radio frequency signals via the antennas 712 and through the antenna switching circuitry 710 from one or more base stations. A low-noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using ADCs.

The baseband processor 704 processes the digitized received signal to extract the information or data bits conveyed in the received signal. This processing typically comprises demodulation, decoding, and error correction operations, as will be discussed in greater detail below. The baseband processor 704 is generally implemented in one or more digital signal processors (DSPs) and ASICs.

For transmission, the baseband processor 704 receives digitized data, which may represent voice, data, or control information, from the control system 702, which it encodes for transmission. The encoded data is output to the transmit circuitry 706, where DACs convert the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 712 through the antenna switching circuitry 710. The multiple antennas 712 and the replicated transmit circuitry 706 and receive circuitry 708 may provide spatial diversity. Modulation and processing details will be understood by those skilled in the art.

Those skilled in the art will recognize improvements and modifications to the preferred embodiments of the present disclosure. All such improvements and modifications are considered within the scope of the concepts disclosed herein and the claims that follow.

What is claimed is:

1. Radio frequency (RF) front-end circuitry, comprising:
a first transceiver circuit comprising a first filter network and first downstream/upstream RF circuitry, wherein the first downstream/upstream RF circuitry is configured to be operational and non-operational based on a first control output;
a second transceiver circuit comprising a second filter network and second downstream/upstream RF circuitry, wherein the second downstream/upstream RF circuitry is configured to be operational and non-operational based on a second control output;
a switch device connected to an antenna, wherein the switch device is configured to selectively couple and selectively decouple the first transceiver circuit and the second transceiver circuit to the antenna; and
control circuitry configured to:
selectively couple both the first transceiver circuit and the second transceiver circuit to the antenna;
generate the first control output such that the first downstream/upstream RF circuitry is operational with the first filter network while both the first transceiver circuit and the second transceiver circuit are selectively coupled to the antenna; and
generate the second control output such that the second downstream/upstream RF circuitry is non-operational with the second filter network while both the first transceiver circuit and the second transceiver circuit are selectively coupled to the antenna and while the first downstream/upstream RF circuitry is operational with the first filter network.

2. The RF front-end circuitry of claim 1, further comprising a third transceiver circuit comprising a third filter network and third downstream/upstream RF circuitry, wherein the third downstream/upstream RF circuitry is configured to be operational and non-operational with the third filter network based on a third control output, wherein:
the switch device is configured to selectively couple and selectively decouple the third transceiver circuit to the antenna; and
the control circuitry is further configured to:
selectively couple the third transceiver circuit to the antenna; and
generate the third control output such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network.

3. The RF front-end circuitry of claim 1, wherein the first filter network comprises a first Bulk Acoustic Wave (BAW) filter or a first Surface Acoustic Wave (SAW) filter.

4. The RF front-end circuitry of claim 3, wherein the first filter network comprises a second BAW filter or a second SAW filter.

5. The RF front-end circuitry of claim 1, wherein the second filter network comprises a first Bulk Acoustic Wave (BAW) filter or a first Surface Acoustic Wave (SAW) filter.

6. The RF front-end circuitry of claim 1, wherein the first filter network defines a first passband in a first frequency range.

7. The RF front-end circuitry of claim 6, wherein the second filter network defines a second passband that is outside the first frequency range.

8. The RF front-end circuitry of claim 7, wherein the second filter network provides a capacitive response within the first frequency range.

9. A method of operating radio frequency (RF) front-end circuitry, the method comprising:
selectively coupling both a first transceiver circuit and a second transceiver circuit to an antenna, wherein the first transceiver circuit comprises a first filter network and first downstream/upstream RF circuitry, wherein the first downstream/upstream RF circuitry is configured to be operational and non-operational with the first filter network based on a first control output, wherein the second transceiver circuit comprises a second filter network and second downstream/upstream RF circuitry, and wherein the second downstream/upstream RF circuitry is configured to be operational and non-operational with the second filter network based on a second control output;
generating the first control output such that the first downstream/upstream RF circuitry is operational with the first filter network while both the first transceiver circuit and the second transceiver circuit are selectively coupled to the antenna; and
generating the second control output such that the second downstream/upstream RF circuitry is non-operational with the second filter network while both the first transceiver circuit and the second transceiver circuit are selectively coupled to the antenna and the first downstream/upstream RF circuitry is operational with the first filter network.

10. The method of claim 9, further comprising:
selectively coupling a third transceiver circuit to the antenna, wherein the third transceiver circuit comprises a third filter network and third downstream/upstream RF circuitry, wherein the third downstream/upstream RF circuitry is configured to be operational and non-operational with the third filter network based on a third control output; and
generating the third control output such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network.

11. The method of claim 9, wherein the first filter network comprises a first Bulk Acoustic Wave (BAW) filter or a first Surface Acoustic Wave (SAW) filter.

12. The method of claim 11, wherein the first filter network comprises a second BAW filter or a second SAW filter.

13. The method of claim 9, wherein the second filter network comprises a first Bulk Acoustic Wave (BAW) filter or a first Surface Acoustic Wave (SAW) filter.

14. The method of claim 9, wherein the first filter network defines a first passband in a first frequency range.

15. The method of claim 14, wherein the second filter network defines a second passband that is outside the first frequency range.

16. The method of claim 15, wherein the second filter network provides a capacitive loading within the first frequency range.

17. A user element comprising Radio Frequency (RF) front-end circuitry, the RF front-end circuitry comprising:
a first transceiver circuit comprising a first filter network and first downstream/upstream RF circuitry, wherein the first downstream/upstream RF circuitry is configured to be operational and non-operational based a first control output;
a second transceiver circuit comprising a second filter network and second downstream/upstream RF circuitry, wherein the second downstream/upstream RF circuitry is configured to be operational and non-operational based on a second control output;
a switch device connected to an antenna, wherein the switch device is configured to selectively couple and selectively decouple the first transceiver circuit and the second transceiver circuit to the antenna; and
control circuitry configured to:
selectively couple both the first transceiver circuit and the second transceiver circuit to the antenna;
generate the first control output such that the first downstream/upstream RF circuitry is operational with the first filter network while both the first transceiver circuit and the second transceiver circuit are selectively coupled to the antenna; and
generate the second control output such that the second downstream/upstream RF circuitry is non-operational with the second filter network while both the first transceiver circuit and the second transceiver circuit are selectively coupled to the antenna and while the first downstream/upstream RF circuitry is operational with the first filter network.

18. The user element of claim 17, wherein the RF front-end circuitry further comprises a third transceiver circuit comprising a third filter network and third downstream/upstream RF circuitry, wherein the third downstream/upstream RF circuitry is configured to be operational and non-operational with the third filter network based on a third control output, wherein:
the switch device is configured to selectively couple and selectively decouple the third transceiver circuit to the antenna; and
the control circuit is further configured to:
selectively couple the third transceiver circuit to the antenna; and
generate the third control output such that the third downstream/upstream RF circuitry is operational with the third filter network while the second downstream/upstream RF circuitry is non-operational with the second filter network, while both the first transceiver circuit and the second transceiver circuit are selectively coupled to the antenna, and while the first downstream/upstream RF circuitry is operational with the first filter network.

19. The user element of claim 17, wherein the first filter network comprises a first Bulk Acoustic Wave (BAW) filter or a first Surface Acoustic Wave (SAW) filter.

20. The user element of claim 19, wherein the first filter network comprises a second BAW filter or a second SAW filter.
